(19) United States
(12) Patent Application Publication
(10) Pub. No.: US 2011/0148867 A1
(43) Pub. Date: Jun. 23, 2011

(54) SHAPE OPTIMIZATION TECHNIQUE

(75) Inventors: Hitoshi YANAMI, Kawasaki (JP); Hirokazu ANAI, Kawasaki (JP); Hidenao IWANE, Kawasaki (JP)

(73) Assignee: FUJITSU LIMITED, Kawasaki-shi (JP)

(21) Appl. No.: 12/971,958

(22) Filed: Dec. 17, 2010

(30) Foreign Application Priority Data
Dec. 22, 2009 (JP) 2009-290050

(51) Int. Cl. G06T 15/00

(52) U.S. Cl. 345/419

(57) ABSTRACT

A shape optimization method includes: obtaining parameter data including data concerning a first relational expression that causes coordinate values of plural vertexes in at least a portion of an object to be changed together and includes a parameter capable of setting values from outside; determining, according to a predetermined algorithm, a value of the parameter in the parameter data; calculating coordinates values of the plural vertexes from a second relational expression determined by the first relational expression and the determined value of the parameter; generating shape data including coordinate values of first vertexes to define the shape of the object from initial coordinate values and the calculated coordinate values; causing to execute cost calculation of the shape defined by the shape data; and outputting shape data in case of a best result of the cost calculation after repeating the aforementioned processing based on a result of the cost calculation.

### CROSS-REFERENCE TO RELATED APPLICATIONS

This application is based upon and claims the benefit of priority of the prior Japanese Patent Application No. 2009-290050, filed on Dec. 22, 2009, the entire contents of which are incorporated herein by reference.

### FIELD

This technique relates to a technique for optimizing a shape of an object to be designed.

### BACKGROUND

For example, there are some design support techniques for optimizing a shape of a component. Specifically, a Computer Aided Design (CAD) system for forming a shape model of the component and an optimization system for optimizing the shape of the component based on the shape model received from the CAD system are provided. Then, in the optimization system, conditions required for an analysis are inputted, and the shape model of the component is simplified, and the optimized shape model of the component is calculated based on the inputted conditions and the simplified shape model. After that, this optimized shape model is outputted to the CAD system from the optimization system. However, there is no special means for a portion to efficiently generate the optimized and detailed shape model from the simplified shape model.

In addition, the design support techniques includes a technique for calculating plural objective functions based on predetermined calculation after inputting plural sets of design parameter values, and supporting the determination of a set of the optimum design parameter values by executing multiobjective optimization processing for plural objective functions. More specifically, first, a set of plural objective functions is calculated for a set of sample values for a predetermined number of sets of design parameters, and an objective function is approximated by equations based on the set of samples values for a predetermined number of sets of design parameters and the set of plural calculated objective functions. Then, a logical expression representing a logical relationship between two or three arbitrary objective functions among the plural objective functions approximated by equations is calculated as a logical expression between the objective functions. Based on this logical expression between the objective functions, feasible regions that are regions in which values of the two or three arbitrary objective functions may occur are displayed. However, the user is requested to select optimum parameter values from such feasible regions.

The aforementioned conventional arts do not disclose any specific method of how to change and evaluate (e.g. calculate the cost of) the detailed shape of the object to be designed, in order to efficiently obtain the optimized shape.

### SUMMARY

According to one aspect of this technique, a method for optimizing a shape of an object to be designed includes: (A) reading out parameter data including data concerning a first relational expression that causes coordinate values of a plurality of vertexes in at least a portion of the object to be changed together and includes a parameter that is capable of setting values from outside, from a parameter data storage device storing the parameter data; (B) determining, according to a predetermined algorithm, a value of the parameter in the parameter data; (C) calculating coordinates values of the plurality of vertexes from a second relational expression determined by the first relational expression and the determined value of the parameter; (D) generating shape data including coordinate values of first vertexes to define the shape of the object from initial coordinate values of second vertexes to define the shape of the object, which are stored in an initial shape data storage device, and the calculated coordinate values, and storing the shape data into a shape data storage device; (E) causing to execute cost calculation to evaluate the shape of the object, which is defined by the shape data, by using the shape data stored in the shape data storage device; and outputting shape data in case of a best result of the cost calculation after repeating the determining, the calculating, the generating and storing and the causing based on a result of the cost calculation.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a functional block diagram of a shape optimization apparatus relating to an embodiment of this technique;

FIG. 2 is a diagram depicting an example of an Air Bearing Surface (ABS) slider;

FIG. 3 is a diagram depicting a main processing flow of this embodiment;

FIG. 4 is a diagram depicting data example of an initial shape file stored in an initial shape file storage;

FIG. 5 is a diagram depicting an example of data stored in a parameter setting file;

FIG. 6 is a diagram to explain a problem in case of defining using a first format in the parameter setting file;

FIG. 7 is a diagram depicting an example of a shape to be considered;

FIG. 8 is a diagram depicting an example of an undesirable shape;

FIG. 9 is a diagram depicting an example of vertexes moving together;

FIG. 10 is a diagram depicting a processing flow of a shape file generation processing;

FIG. 11 is a diagram depicting calculated interpolating points;

FIG. 12 is a diagram depicting an example of data stored in a shape file;

FIG. 13 is a diagram depicting another example of the Bezier curve having one parameter;

FIG. 14 is a diagram depicting still another example of the Bezier curve having one parameter;

FIG. 15 is a diagram depicting an example of the Bezier curve having two parameters;

FIG. 16 is a diagram depicting an example of the Bezier curve having two parameters;

FIG. 17 is a diagram depicting an example of the Bezier curve having two parameters;

FIG. 18 is a diagram depicting an example of the Bezier curve having two parameters;

FIG. 19 is a diagram depicting an example of the Bezier curve having two parameters;

FIG. 20 is a diagram depicting an example of the Bezier curve having two parameters;

FIG. 21 is a functional block diagram of a computer; and

FIG. 22 is a functional block diagram of a shape optimization apparatus of an object to be designed.

### DESCRIPTION OF EMBODIMENTS

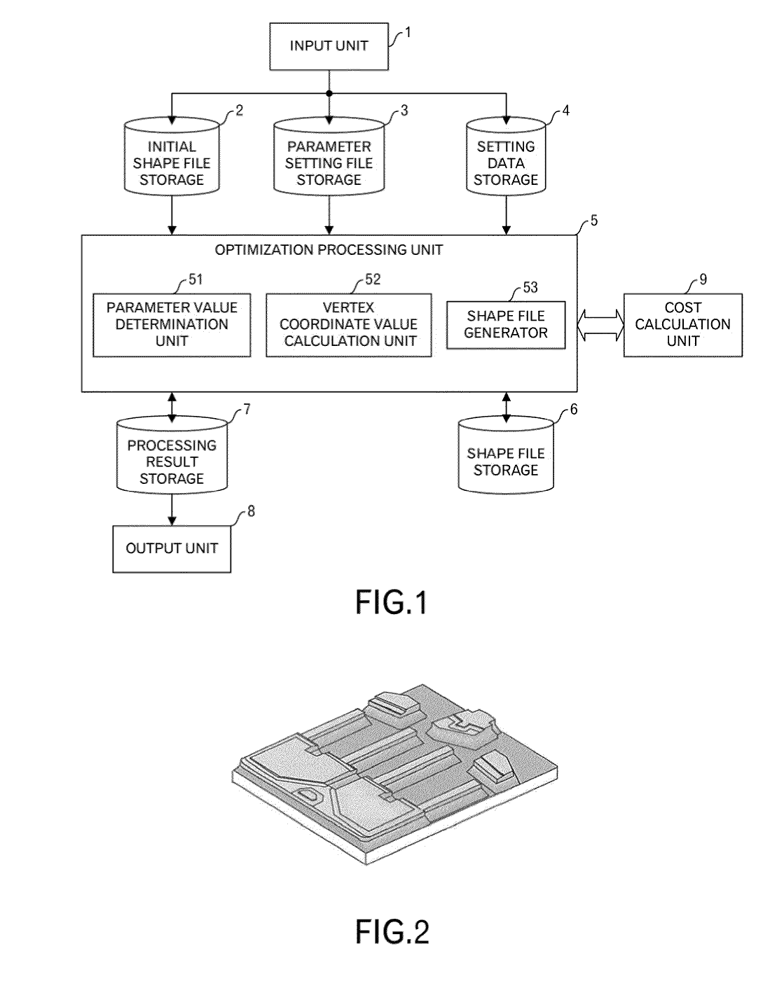

FIG. 1 depicts a functional block diagram of a shape optimization apparatus relating to this embodiment of this technique. This shape optimization apparatus has (A) an input unit 1 that obtains data required for following processing from a user or other computers; (B) an initial shape file storage 2 storing an initial shape file obtained by the input unit 1; (C) a parameter setting file storage 3 storing a parameter setting file obtained by the input unit 1; (D) a setting data storage 4 storing setting data obtained by the input unit 1; (E) an optimization processing unit 5 that carries out a processing to optimize the shape of the object to be designed, while cooperating with the cost calculation unit 9; (F) a shape file storage 6 storing a shape file generated and used by the optimization processing unit 5; (G) a processing result storage 7 storing processing results of the optimization processing unit 5; and (H) an output unit 8 that output data stored in the processing result storage 7 to an output device (e.g. display device or printer) or other computers.

In addition, the optimization processing unit 5 includes a parameter value determination processing unit 51, a vertex coordinate value calculation unit 52 and a shape file generator 53.

For example, when the object to be designed is an Air Bearing Surface (ABS) slider (e.g. as depicted in FIG. 2) equipped under a tip of an actuator, which moves on a magnetic disc in a hard disk drive, the cost calculation unit 9 is a well-known flying calculation simulator. This flying calculation simulator calculates a flying cost for an inputted shape. However, this technique is not a technique peculiar to the shape of the ABS slider and can be applied to shapes of other components or products. In addition, the cost calculation unit 9 may be included in the shape optimization apparatus, or may be implemented in one or plural other computers connected to this shape optimization apparatus through a network. When there are plural computers (including a case where there are plural CPUs (Central Processing Units) in one computer), parallel processing becomes possible for plural shapes, and the cost calculation is carried out fast.

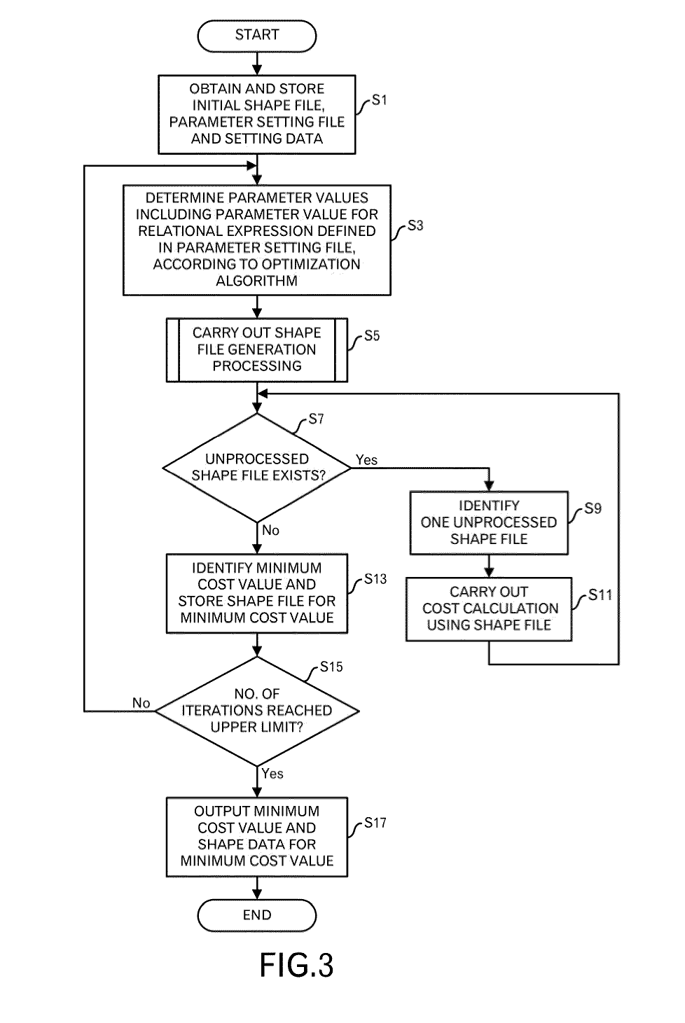

Next, processing contents of the shape optimization apparatus depicted in FIG. 1 will be explained by using FIGS. 3 to 20. For example, the input unit 1 accepts inputs and designation from the user, obtains an initial shape file, a parameter setting file and setting data, and stores the initial shape file into the initial shape file storage 2, the parameter setting file into the parameter setting file storage 3 and the setting data into the setting data storage 4 (FIG. 3: step S1). The setting data stored in the setting data storage 4 is data such as an upper limit of the number of iterations of a processing to be carried out in the following, data representing value ranges of the parameters and the like.

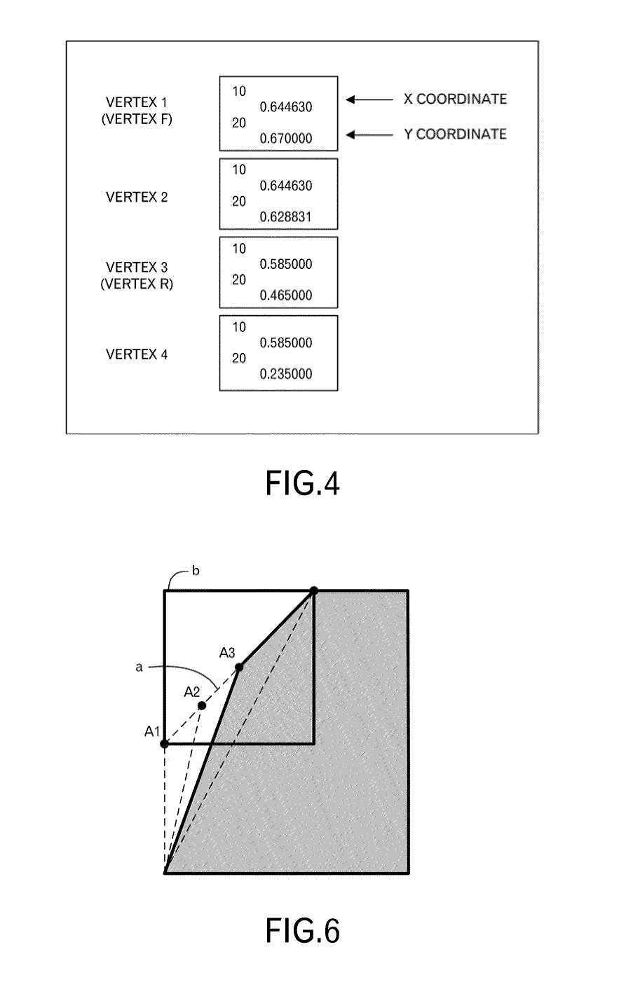

FIG. 4 depicts data example in the initial shape file stored in the initial shape file storage 2. In the example of FIG. 4, X and Y coordinate values are set as initial values of the initial position for each of vertexes 1 to 4. Furthermore, X and Y coordinate values for the vertexes, which are not depicted in Figure, are also set. Incidentally, in the following example, the vertex 1 corresponds to a vertex F, and the vertex 3 corresponds to a vertex R.

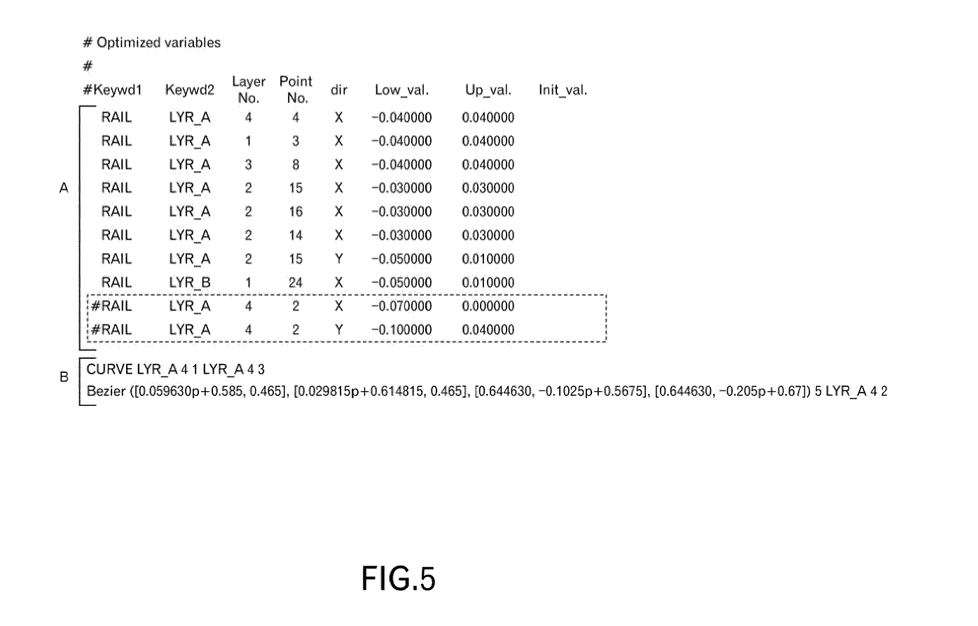

In addition, FIG. 5 depicts data example of the parameter setting file stored in the parameter setting file storage 3. The parameter setting file defines, in two formats, a method of how to change the initial positions of the vertexes defined in the initial shape file. As depicted in a portion A of FIG. 5, the first format is to change X or Y coordinate value (in a column of dir) of the vertex identified from keyword 1 (denoted as “Keywd1”), keyword 2 (denoted as “keywd2”), layer number (denoted as “LayerNo.”) and vertex number (denoted as “PointNo.”) from the lower limit value (denoted as “Low_val”) to the upper limit value (denoted as“Up_val”). Incidentally, the initial value is defined in a column of Init_val, if it exists. For example, in case of “RAIL LYR_A4 4 X −0.04000 0.04000”, X coordinate value of the 4th vertex (e.g. vertex 4 in FIG. 4) in a portion “RAIL LYR_A4” is changed from −0.04000 to +0.04000. Incidentally, in this case, there is no initial value. By using this data and X coordinate value “0.585” of the vertex 4 in FIG. 4 are used, it can be understood that X coordinate value of the vertex 4 is changed from 0.535 to 0.615.

On the other hand, as depicted in a portion B of FIG. 5, the second format defines a relational expression to move plural vertexes together. This portion B “CURVE LYR_A 4 1 LYR_A 4 3 Bezier (P0, P1, P2, P3) 5 LYR_A 4 2” contains following contents. Namely, “CURVE” is a statement defining the relational expression, “LYR_A 4 1” defines a first vertex (e.g. vertex 1 in FIG. 4 (which corresponds to vertex F)), and “LYR_A 4 3” defines a second vertex (e.g. vertex 3 in FIG. 4 (which corresponds to vertex R)). Bezier (P0, P1, P2, P3) defines that interpolating points, which are connected by the Bezier curve whose control points are points P0 to P3, are arranged between the first and second vertexes. Incidentally, as for P0 to P3, the actual coordinates values of the control points are actually described as depicted in FIG. 5. Of course, it is also possible to define a straight line or curves such as B spline. The control points are defined so as to change by the parameter p, and the user defines it, appropriately. “5” defines that 5 interpolating points (also called as vertexes) are generated by the relational expression, and “LYR_A 4 2” (e.g. vertex 2 in FIG. 4) defines a vertex to be deleted in the initial shape file. Incidentally, a vertex may be added without deleting the vertex.

According to the first format as described in the portion A of FIG. 5, it is impossible to define that the vertex A is moved to the vertexes A1, A2 and A3 along the straight line or curve a, as depicted in FIG. 6. Namely, the first format can define that the vertex is moved only in a direction parallel to the X axis or Y axis. Therefore, because the X coordinate value and Y coordinate value are set independently, the vertex A is moved within a range of a rectangle b.

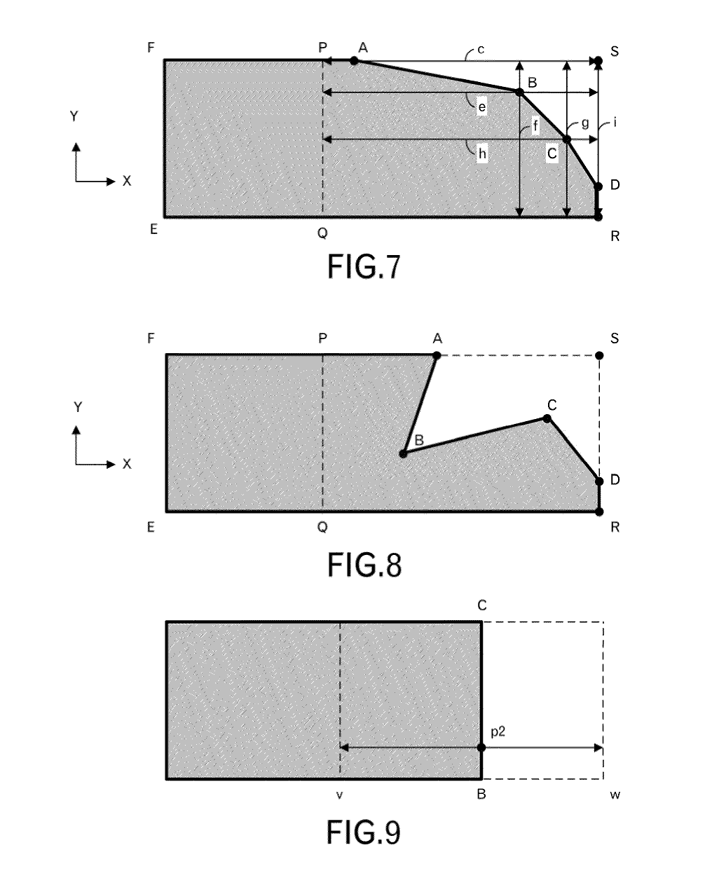

When the vertex to be moved is only one vertex, the problem is few. However, as depicted in FIG. 7, when beveling so as to connect, via a smooth curve, the vertexes from the vertex F to the vertex R in the rectangle EFSR, the problem is large. Specifically, the aforementioned first format defines vertexes A to D, and also respectively defines a range in which the coordinate values can be changed. Then, in the shape optimization processing, after coordinate values for the vertexes A to D are determined in the defined ranges to respectively identify the specific vertexes A to D one by one, the cost calculation such as the flying cost or the like is carried out.

In the example of FIG. 7, a movement range of the vertex A is defined as “qx≦Ax (X coordinate value of the vertex A)≦sx”, and the vertex A moves from qx to sx on an edge FS, as depicted by an arrow c. “qx” is X coordinate value of the vertex Q, and “sx” is X coordinate value of the vertex S. In addition, a movement range of the vertex B is defined as “qx≦Bx (X coordinate value of the vertex B)≦sx” and “qy≦By (Y coordinate value of the vertex B)≦sy”, and the vertex B flatly moves on a rectangle PQRS, as depicted by arrows f and e. “qy” is Y coordinate value of the vertex Q, and “sy” is Y coordinate value of the vertex S. Similarly, a movement range of the vertex C is defined as “qx≦Cx (X coordinate value of the vertex C)≦sx” and “qy≦Cy (Y coordinate value of the vertex C)≦sy”, and the vertex C flatly moves on a rectangle PQRS, as depicted by arrows h and g. Furthermore, a movement range of the vertex D is defined as “qy≦Dy (Y coordinate value of the vertex D) sy”, and the vertex D moves from qy to sy, on an edge SR, as depicted by an arrow i. Thus, a shape whose cost is minimum is searched by carrying out the cost calculation while changing 6 parameters such as Ax, Bx, By, Cx, Cy and Dy. However, according to the aforementioned range designation method, a concave hexagon FABCDR, not a convex hexagon FABCDR, is identified as a shape as designated by the first format, as depicted in FIG. 8 and the cost calculation for such concave hexagon FABCDR is carried out.

Such a trouble can be solved by the second format. For example, when it is defined that the Bezier curve, for example, connects a range from the vertex F to the vertex R, the vertexes between them moves together along with the shape of the Bezier curve. Especially, because only the parameter p is changed in case of the Bezier curve defined in FIG. 5, it is possible to reduce the number of parameters to be changed. Incidentally, the parameter p of the Bezier curve is a value from 0 to 1. This leads to the large reduction of the number of cost calculations, and the efficiency improvement of the processing can be enhanced. For example, the movement of the vertexes follows the Bezier curve. Therefore, the concave hexagon depicted in FIG. 8 is not formed.

Incidentally, the last two lines in the portion A of FIG. 5 describe a case where it is assumed that the movement of the vertex 2 is defined (# represents invalid.). As described above, the first format can define only a matter that X and Y coordinate values are changed independently. Therefore, the vertex flatly moves. Furthermore, it is impossible to move the vertex along the smooth curve like the second format.

Although there is no indication in the portion A in FIG. 5, it is possible even for the first format to define simple movement that the vertex B is moved together with the vertex C. For example, by defining Cx is equal to Bx after defining v≦Bx≦w, it is possible to define the right or left movement of the edge CB. The same matter can be defined by the second format.

Returning to the explanation of the processing depicted in FIG. 3, the parameter value determination unit 51 of the optimization processing unit 5 determines, according to a predetermined optimization algorithm, parameter values including the parameter value for the relational expression defined in the parameter setting file stored in the parameter setting file storage 3 by using the initial shape file stored in the initial shape file storage 2, and stores the determined parameter values into a storage device such as a main memory (step S3). A well-known method can be adopted for the optimization algorithm, such as a random sampling method, Brent method, Nelder-Mead method, Powell method, Steepest descent method, Conjugate gradient method, Genetic algorithm, Simulated Annealing, Differential evolution algorithm, or Particle Swarm Optimization. At this step, as for the parameter for which the range (also called as a value range) is defined by the first or second format, one value is determined within the range designated for the parameter other than a specific parameter. As for the specific parameter, the designated entire range or its partial range is determined. When the range such as “from −0.0400 to +0.0400” as depicted in FIG. 5 is designated, the parameter value “+0.01” is used as a parameter value of X coordinate value of the vertex “LYR_A_{—}4_{—}4”. Incidentally, the result of adding the parameter value with the initial coordinate value designated in the initial shape file, for example, the value “0.595” in the above case, may be treated as a parameter value. In case of the parameter for the relation expression, the designated p or the like is determined. Incidentally, the parameter value determination unit 51 outputs the determined parameter values to the shape file generator 53.

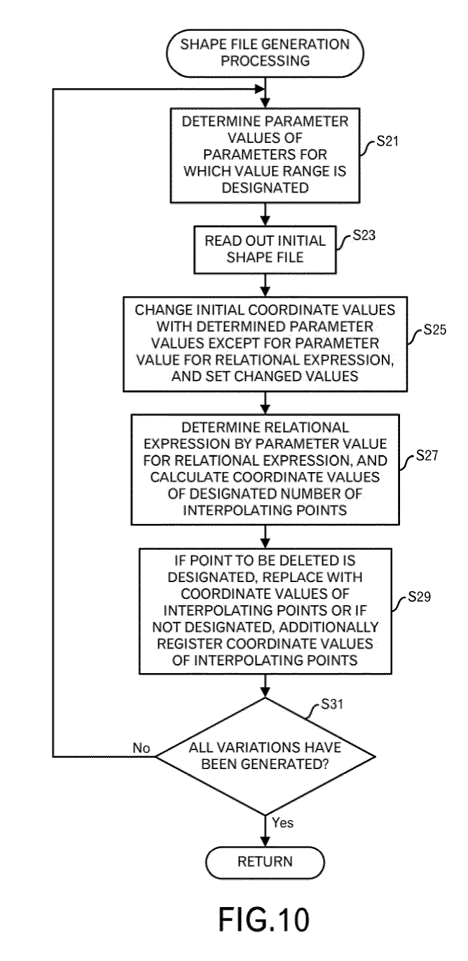

Then, the shape file generator 53 carries out a shape file generation processing by using the determined parameter values, and stores the generated shape file into the shape file storage 6 (step S5). This shape file generation processing will be explained by using FIGS. 10 to 20.

First, the shape file generator 53 determines one parameter value of the parameter for which the range is designated (FIG. 10: step S21). For example, when 10 values are determined, one value is determined among 10 subranges generated by equally dividing the designated range by “10”. The upper limit value, the lower limit value and values equally arranged between the upper limit value and the lower limit value may be simply selected, and unselected one value may be adopted at this step among the selected values.

Then, the shape file generator 53 reads out the initial shape file from the initial shape file storage 2 (step S23), change the corresponding value in the initial shape file by the determined parameter values, except for the parameter value for the relational expression, and sets the changed values into the initial shape file (step S25). In the following, the processed initial shape file is treated as a shape file, and is stored into the shape file storage 6.

Furthermore, the vertex coordinate value calculation unit 52 reads out the parameter setting file from the parameter setting file storage 3, identifies a relational expression by data concerning the relational expression, which is identified from the parameter setting file, and the parameter value for the relational expression, calculates the coordinate values of the interpolating points, and stores the calculated coordinate values into the storage device such as the main memory (step S27). The number of interpolating points for which the coordinate values are calculated is designated by the data concerning the relational expression.

In the example of FIG. 5, the control points are defined as follows:

P0=[0.059630p+0.585, 0.465], P1=[0.029815p+0.614815, 0.465], P2=[0.644630, -0.1025p+0.5675], P3=[0.644630, −0.205p+0.67]

Therefore, when the parameter value of the parameter p is determined, the coordinate values of the control points are determined specifically.

For example, in case of p=0.3, following results are obtained:

### P0=[0.602889, 0.465], P1=[0.6237595, 0.465], P2=[0.644630, 0.53675], P3=[0.644630, 0.6085]

The Bezier curve B (t) is represented from the coordinate values of the control points as follows:

Incidentally, P0=[P0x, P0y], P1=[Pix, P1y], P2=[P2x, P2y], P3=[P3x, P3y].

Bx(t)=t³*P3x+t²*(1−t)*P2x+t*(1−t)²*P1x+(1−t)³*P0x

By(t)=t³*P3y+t²*(1−t)*P2y+t*(1−t)²*P1y+(1−t)³*P0y

Incidentally, 0≦t≦1.

Then, by equally dividing a range from the lower limit “0” of t to the upper limit “1” of t by (the designated number −1), the specific values including t=0, t=1 and values at the divided points are determined. For example, when the number of interpolating points is “5”, t=0, t=0.25, t=0.5, t=0.75 and t=1 are determined. Then, Bx(t) and By(t) are calculated for each of them.

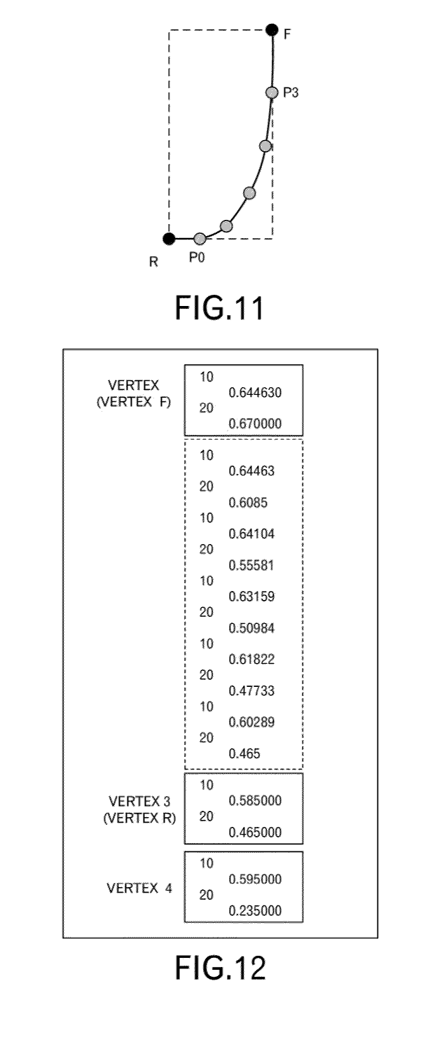

For example, as depicted in FIG. 11, a range from the control point P0 to the control point P3 within a section from the vertex F to the vertex R are connected by the Bezier curve defined by the control points identified with p=0.3, and 3 interpolating points identified with the aforementioned values of t are calculated. The range between the vertex F and the control point P3 and the range between the vertex R and the control point P0 are connected by the straight line.

According to the aforementioned example, the coordinate values of the interpolating points are as follows:

[0.64463, 0.6085], [0.64104, 0.55581], [0.63159, 0.50984], [0.61822, 0.47733], [0.60289, 0.465]

The vertex coordinate value calculation unit 52 outputs the calculated coordinate values of the interpolating points to the shape file generator 53. Incidentally, plural relational expressions may be defined in the parameter setting file. In such a case, the step S27 is carried out for each of the relational expressions.

The shape file generator 53 confirms whether or not the data concerning the relational expression, which is identified from the parameter setting file, includes a point to be deleted, and if included, replaces the coordinate values of the point to be deleted in the shape file with the coordinate values of the interpolating points or if not included, additionally registers the coordinate values of the interpolating points into the shape file (step S29).

The initial shape file depicted in FIG. 4 is changed to a file as depicted in FIG. 12. There is no change for the vertexes 1 (i.e. vertex F) and 3 (i.e. vertex R). However, data of the vertex 2 is deleted and replaced with the coordinate values of the 5 interpolating points as surrounded by dotted lines. Furthermore, X coordinate value of the vertex 4 is replaced with the value change at the step S25.

Then, the shape file generator 53 judges whether or not all variations are generated for parameters for which the range is designated (step S31), and when there is any unprocessed variation, the processing returns to the step S21.

By carrying out the aforementioned processing, plural shape files are generated and stored into the shape file storage 6.

Returning to the explanation of the processing of FIG. 3, the optimization processing unit 5 judges whether or not there is an unprocessed shape file in the shape file storage 6 (step S7). When there is an unprocessed shape file, the optimization processing unit 5 identifies and reads out one unprocessed shape file from the shape file storage 6, and outputs the shape file and other data required for the cost calculation to the cost calculation unit 9 (step S9). The cost calculation unit 9 receives data from the optimization processing unit 5, carries out a well-known cost calculation processing by using the data received from the optimization processing unit 5 such as the shape file (step S11), and outputs the cost value as a result of the cost calculation to the optimization processing unit 5. Then, the processing shifts to the step S7. The optimization processing unit 5 receives the cost value from the cost calculation unit 9, and stores the cost value into the processing result storage 7 in association with an identifier of the shape file used for this processing.

On the other hand, when there is no unprocessed shape file, the optimization processing unit 5 identifies the minimum cost value among the cost values obtained in this iteration and the past minimum cost value in the past iterations, and stores the identified minimum cost value into the processing result storage 7, and when the minimum cost value is identified among the cost values obtained in this iteration, reads out the shape file at that time, and stores data (called as shape data) of the read shape file into the processing result storage 7 (step S13). The parameter values for the minimum cost value may be stored into the processing result storage 7.

Then, the optimization processing unit 5 reads out the upper limit of the number of iterations from the setting data storage 4, and judges whether or not the number of iterations reached the upper limit (step S15). When the number of iterations did not reach the upper limit, the processing returns to the step S3. For example, new parameter values are determined, according to the predetermined algorithm, by using data (e.g. history of the minimum cost values and parameter values for the minimum cost values) stored in the processing result storage 7.

On the other hand, when the number of iterations reached the upper limit, the output unit 8 reads out the minimum cost value for the entire processing and shape data for the minimum cost value from the processing result storage 7, and outputs the read data to an output device or another computer (step S17). Thus, the user, namely, the designer can obtain the shape data with the minimum cost.

Thus, by introducing the relational expression that can move plural vertexes together, it becomes possible to identify a shape having the minimum cost among possible shapes, while reducing the number of parameters. In other words, it becomes possible to reduce the number of times of the cost calculation and to obtain the most suitable shape more effectively.

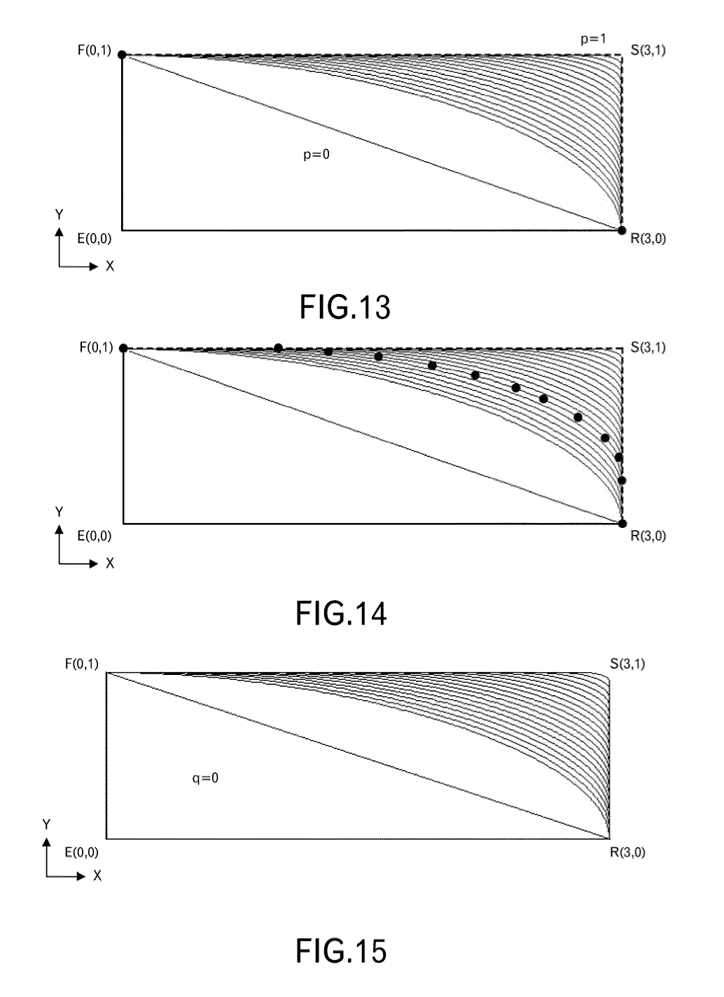

In the following, the processing at the step S27 will be explained by using another specific example. As depicted in FIG. 13, for example, the vertex E is arranged at (0,0), the vertex F is arranged at (0,1), the vertex S is arranged at (3,1) and the vertex R is arranged at (3,0). Then, a case is considered that a range from the control point nearest to the vertex F to the control point nearest to the vertex R is connected by the Bezier curve. At this case, it is assumed that the following points are designated as control points:

[3*p, 1], [3/2*p+3/2, 1], [3, 1/2*p+1/2], [3, p]

The value range of the parameter p is a range from 0 to 1. As depicted in FIG. 13, in case of p=0, a straight line connecting the vertex F and the vertex R is obtained, and in case of p=1, a curve passing in the vicinity of the vertex S most is obtained. In addition, FIG. 13 also depicts the other Bezier curves whose value of p is at 0.05 intervals within a range from 0 to 1.

In such a case, 11 interpolating points are generated, and in case of p=0.3, following interpolating points are calculated. Incidentally, t of the Bezier curve B(t) is one of points obtained by dividing a range from 0 to 1 by 10 (=11-1).

[0.9, 1.0], [1.2140, 0.98985], [1.5216, 0.96080], [1.8166, 0.91495], [2.0928, 0.85440], [2.3438, 0.78125], [2.5632, 0.69760], [2.7448, 0.60555], [2.8824, 0.50720], [2.9696, 0.40465], [3.0, 0.3]

Those interpolating points are arranged on the Bezier curve depicted in FIG. 14. Thus, the cost calculation is carried out for smooth shapes that are near the designer's intention by a small number of parameters. The shape that is almost the intention of the designer is provided.

In the aforementioned example, one parameter is defined in the relational expression. However, this embodiment is not limited to such a relational expression. For example, it is possible to define the Bezier curve by two parameters. In a case similar to FIG. 13, following points as the control points may be designated. The value range of p and q is a range from 0 to 1.

[3*p, 1], [3/2*p+3/2+q*(−3/20+3*p/20), 1+q*(−9/20+9/20*p)], [3+q*(−3/20+3/20*p), 1/2*p+1/2+q*(−9/20+9/20*p)], [3, p]

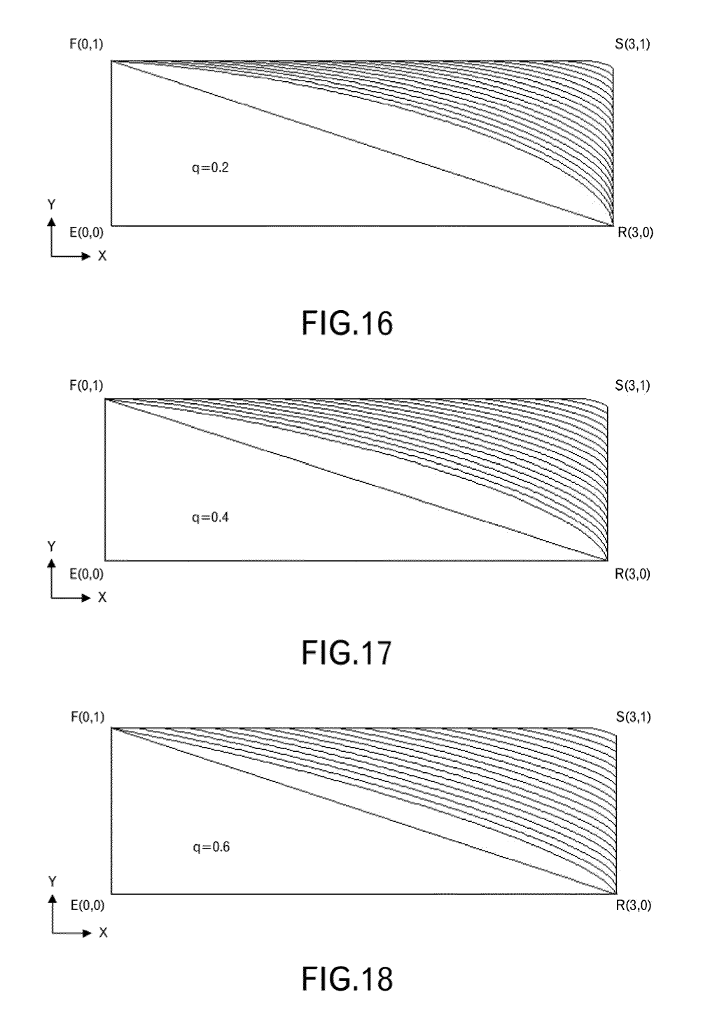

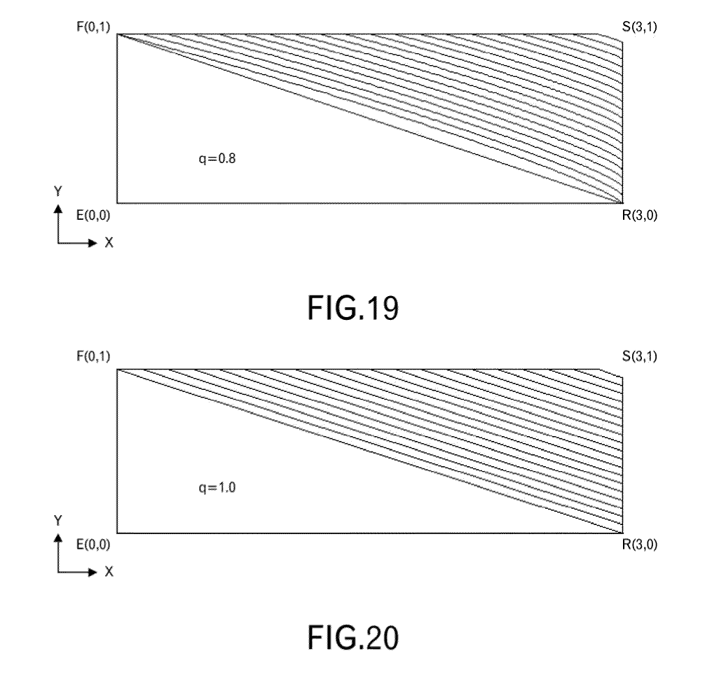

In this example, the lesser q is, the rounder the curve is, and the larger q is, the linearer the curve is. When depicting the examples, FIGS. 15 to 20 are obtained. FIG. 15 depicts a curve when changing the value of p at 0.05 intervals within a range from p=0 to 1, in case of q=0. FIG. 16 depicts a curve when changing the value of p at 0.05 intervals within a range from p=0 to 1, in case of q=0.2. FIG. 17 depicts a curve when changing at 0.05 intervals within a range from p=0 to 1, in case of q=0.4. FIG. 18 depicts a curve when changing at 0.05 intervals within a range from p=0 to 1, in case of q=0.6. FIG. 19 depicts a curve when changing at 0.05 intervals within a range from p=0 to 1, in case of q=0.8. FIG. 20 depicts a curve when changing at 0.05 intervals within a range from p=0 to 1, in case of q=1.0.

Thus, p and q are determined, a specific Bezier curve is determined, and then, the coordinate values of the interpolating points are calculated according to the number of interpolating points.

When the number of parameters increases, the cost calculation is carried out for a lot of curves. However, there is possibility that more appropriate shape is identified.

Although the embodiment of this technique was explained, this technique is not limited to this embodiment. For example, the functional block diagram of FIG. 1 is a mere example, but does not always correspond to an actual program module configuration.

In addition, as long as the processing result does not change, the processing flow may be changed. For example, a loop from the steps S7 to S11 may be executed in parallel by plural cost calculation units. Furthermore, a loop from the steps S3 to S15 may be executed in parallel by plural computers.

Furthermore, the Bezier curve is a mere example, and a straight line or other curves such as an exponential function may be used. This is selected arbitrarily by the designer. Furthermore, the number of control points is also arbitrary. Furthermore, although the aforementioned example is directed to the two dimensional design, this technique can be applied to the three dimensional design in the three dimensional space.

In addition, because the processing flow depicted in FIG. 3 is not a flow assuming a specific optimization algorithm, a loop form may be different from the form described in this embodiment. However, searching the shape data whose cost calculated by the cost calculation unit 9 is minimum is also carried out in any mode, and the loop form is not the main issue of this technique.

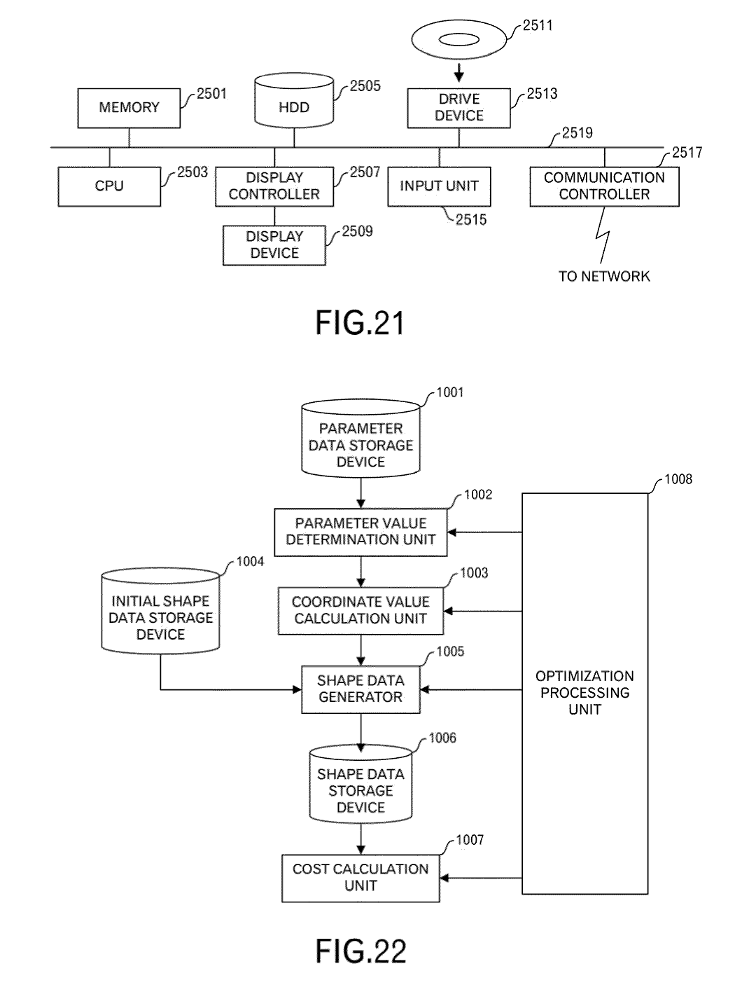

In addition, the shape optimization apparatus is a computer device as shown in FIG. 21. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as shown in FIG. 21. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

The aforementioned embodiment is outlined as follows:

A method for optimizing a shape of an object to be designed includes: (A) reading out parameter data including data concerning a first relational expression that causes coordinate values of a plurality of vertexes in at least a portion of the object to be changed together and includes a parameter that is capable of setting values from outside, from a parameter data storage device storing the parameter data; (B) determining, according to a predetermined algorithm, a value of the parameter in the parameter data; (C) calculating coordinates values of the plurality of vertexes from a second relational expression determined by the first relational expression and the determined value of the parameter; (D) generating shape data including coordinate values of first vertexes to define the shape of the object from initial coordinate values of second vertexes to define the shape of the object, which are stored in an initial shape data storage device, and the calculated coordinate values, and storing the shape data into a shape data storage device; (E) causing to execute cost calculation to evaluate the shape of the object, which is defined by the shape data, by using the shape data stored in the shape data storage device; and outputting shape data in case of a best result of the cost calculation after repeating the determining, the calculating, the generating and storing and the causing based on a result of the cost calculation.

Thus, by appropriately defining the relational expression including a parameter that is capable of setting a value from the outside, it is possible to reduce the number of parameters to be treated without moving the coordinate values of the individual vertexes. Furthermore, the cost calculation for unappropriate shapes can be omitted. Therefore, the processing efficiency of the optimization is entirely enhanced.

Incidentally, the generating may include: discarding initial coordinate values of a specific vertex, when detecting that the data concerning the first relational expression includes data to instruct to discard the initial coordinate values of the specific vertex among the second vertexes stored in the initial shape data storage device. Thus, it becomes possible to freely change the initial shape that has already been given. Incidentally, when there is no data to instruct to discard, the number of vertexes increases by the plurality of vertexes.

In addition, the aforementioned calculating may include: calculating each coordinate value of the plurality of vertexes by allocating values within a value range of a specific variable in said second relational expression to the plurality of vertexes. Thus, it becomes possible to arrange the plurality of vertexes at appropriate positions. When the value range of the specific variable is equally divided, the vertexes are arranged at appropriate intervals on the curve or straight line (curved surface or the like in some cases) defined by the second relational expression.

An apparatus (FIG. 22) for optimizing a shape of an object to be designed, comprising: a parameter data storage device (FIG. 22: 1001) storing parameter data including data concerning a first relational expression that causes coordinate values of a plurality of vertexes in at least a portion of said object to be changed together and includes a parameter that is capable of setting values from outside; a parameter value determination unit (FIG. 22: 1002) to read out the parameter data from the parameter data storage device storing the parameter data, and to determining, according to a predetermined algorithm, a value of the parameter in the parameter data; a coordinate value calculation unit (FIG. 22: 1003) to calculate coordinates values of the plurality of vertexes from a second relational expression determined by the first relational expression and the determined value of said parameter; a shape data generator (FIG. 22: 1005) to generate shape data including coordinate values of first vertexes to define the shape of said object from initial coordinate values of second vertexes to define the shape of the object, which are stored in an initial shape data storage device (FIG. 22: 1004), and the calculated coordinate values and to store the generated shape data into a shape data storage device (FIG. 22: 1006); a cost calculation unit (FIG. 22: 1007) to execute cost calculation to evaluate said shape of said object, which is defined by the shape data, by using the shape data stored in the shape data storage device; and an optimization processing unit (FIG. 22: 1008)to output shape data in case of a best result of the cost calculation by causing the parameter value determination unit, the coordinate value calculation unit, the shape data generator and the cost calculation unit to repeat a processing based on a result of the cost calculation.

Incidentally, it is possible to create a program causing a computer to execute the aforementioned processing, and such a program is stored in a computer readable non-transitory storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable, non-transitory medium storing a program for causing a computer to execute a procedure of optimizing a shape of an object to be designed, said procedure comprising:
reading out parameter data including data concerning a first relational expression that causes coordinate values of a plurality of vertexes in at least a portion of said object to be changed together and includes a parameter that is capable of setting values from outside, from a parameter data storage device storing said parameter data;
determining, according to a predetermined algorithm, a value of said parameter in said parameter data;
calculating coordinates values of said plurality of vertexes from a second relational expression determined by said first relational expression and the determined value of said parameter;
generating shape data including coordinate values of first vertexes to define said shape of said object from initial coordinate values of second vertexes to define said shape of said object, which are stored in an initial shape data storage device, and the calculated coordinate values;
storing the generated shape data into a shape data storage device;
causing to execute cost calculation to evaluate said shape of said object, which is defined by said shape data, by using said shape data stored in said shape data storage device; and
outputting shape data in case of a best result of said cost calculation after repeating said determining, said calculating, said generating, said storing and said causing based on a result of said cost calculation.

2. The computer-readable, non-transitory medium as set forth in claim 1, wherein said generating comprises:
discarding initial coordinate values of a specific vertex, when detecting that said data concerning said first relational expression includes data to instruct to discard said initial coordinate values of said specific vertex among said second vertexes stored in said initial shape data storage device.

3. The computer-readable, non-transitory medium as set forth in claim 1, wherein said calculating comprises:
calculating each coordinate value of said plurality of vertexes by allocating values within a value range of a specific variable in said second relational expression to said plurality of vertexes.

4. A method for optimizing a shape of an object to be designed, comprising:
reading out parameter data including data concerning a first relational expression that causes coordinate values of a plurality of vertexes in at least a portion of said object to be changed together and includes a parameter that is capable of setting values from outside, from a parameter data storage device storing said parameter data;
determining, according to a predetermined algorithm, a value of said parameter in said parameter data;
calculating coordinates values of said plurality of vertexes from a second relational expression determined by said first relational expression and the determined value of said parameter;
generating shape data including coordinate values of first vertexes to define said shape of said object from initial coordinate values of second vertexes to define said shape of said object, which are stored in an initial shape data storage device, and the calculated coordinate values;
storing the generated shape data into a shape data storage device;
causing to execute cost calculation to evaluate said shape of said object, which is defined by said shape data, by using said shape data stored in said shape data storage device; and
outputting shape data in case of a best result of said cost calculation after repeating said determining, said calculating, said generating, said storing and said causing based on a result of said cost calculation.

5. An apparatus for optimizing a shape of an object to be designed, comprising:
a parameter data storage device storing parameter data including data concerning a first relational expression that causes coordinate values of a plurality of vertexes in at least a portion of said object to be changed together and includes a parameter that is capable of setting values from outside;
a parameter value determination unit to read out said parameter data from said parameter data storage device storing said parameter data, and to determining, according to a predetermined algorithm, a value of said parameter in said parameter data;
a coordinate value calculation unit to calculate coordinates values of said plurality of vertexes from a second relational expression determined by said first relational expression and the determined value of said parameter;
a shape data generator to generate shape data including coordinate values of first vertexes to define said shape of said object from initial coordinate values of second vertexes to define said shape of said object, which are stored in an initial shape data storage device, and the calculated coordinate values and to store the generated shape data into a shape data storage device;
a cost calculation unit to execute cost calculation to evaluate said shape of said object, which is defined by said shape data, by using said shape data stored in said shape data storage device; and
an optimization processing unit to output shape data in case of a best result of said cost calculation by causing said parameter value determination unit, said coordinate value calculation unit, said shape data generator and said cost calculation unit to repeat a processing based on a result of said cost calculation.

6. An apparatus for optimizing a shape of an object to be designed, comprising:
a memory configured to store parameter data including data concerning a first relational expression that causes coordinate values of a plurality of vertexes in at least a portion of said object to be changed together and includes a parameter that is capable of setting values from outside; and
a processor configured to execute a procedure, the procedure comprising:
reading out parameter data including data concerning a first relational expression that causes coordinate values of a plurality of vertexes in at least a portion of said object to be changed together and includes a parameter that is capable of setting values from outside, from the memory;
determining, according to a predetermined algorithm, a value of said parameter in said parameter data;
calculating coordinates values of said plurality of vertexes from a second relational expression determined by said first relational expression and the determined value of said parameter;
generating shape data including coordinate values of first vertexes to define said shape of said object from initial coordinate values of second vertexes to define said shape of said object, which are stored in the memory, and the calculated coordinate values;
storing the generated shape data into the memory;
causing to execute cost calculation to evaluate said shape of said object, which is defined by said shape data, by using said shape data stored in the memory; and
outputting shape data in case of a best result of said cost calculation after repeating said determining, said calculating, said generating, said storing and said causing based on a result of said cost calculation.
